(19) United States
(12) Patent Application Publication
(10) Pub. No.: US 2025/0378092 A1
(43) Pub. Date: Dec. 11, 2025

(54) SYSTEMS AND METHOD FOR ENHANCED CONVERSATIONAL PERFORMANCE OF LARGE LANGUAGE MODELS USING ADAPTIVE RETRIEVAL-AUGMENTED GENERATION

(71) Applicant: JPMORGAN CHASE BANK, N.A., New York, NY (US)

(72) Inventors: Najah GHALYAN, Wayne, NJ (US); Richard AMOAKO, Mountain View, CA (US); Mohammed AYUB, Jersey City, NJ (US); Sean MORAN, London (GB); Edward FUNNELL, Lymington (GB)

(21) Appl. No.: 18/735,886

(22) Filed: Jun. 6, 2024

(51) Int. Cl. G06F 16/332; G06F 16/33; G06F 16/34

(52) U.S. Cl. CPC G06F 16/3329; G06F 16/345; G06F 16/3347

(57) ABSTRACT

Systems and methods for enhanced conversational performance of large language models using adaptive retrieval-augmented generation are disclosed. A method may include: (1) receiving a query from a user; (2) retrieving a plurality of summaries of historical conversations from a database of historical conversation summaries similar to the query; (3) generating a first prompt comprising the query and the plurality of summaries; (4) submitting the first prompt to a first large language model (LLM); (5) receiving, from the first LLM, a first response; (6) presenting the first response to the user; (7) generating a second prompt for a summary of the query and the first response; (8) submitting the second prompt to a second LLM; and (9) saving a second response to the second prompt from the second LLM to the database of historical conversation summaries, wherein the second response comprises the summary.

### BACKGROUND OF THE INVENTION

### Field Of the Invention

Embodiments generally relate to systems and methods for enhanced conversational performance of large language models using adaptive retrieval-augmented generation.

### Description of the Related Art

Retrieving change incidents records have been a crucial step for diagnosing various incidents and identifying potential root cause change incidents. In general, when an incident occurs, a filtering tool may be used to retrieve change incidents records pulled from different tables in multiple databases so that the support team can determine the root cause change incidents. The filtering tool, however, cannot leverage text data records of the change incidents that may be used to generate insights for root cause analysis of the incident. This can make the root cause analysis of the incident a challenge and can lead to extensive and prolonged service disruptions for related applications.

### SUMMARY OF THE INVENTION

Systems and methods for enhanced conversational performance of large language models using adaptive retrieval-augmented generation are disclosed. According to an embodiment, a method may include: (1) receiving, at a computer program, a query from a user; (2) retrieving, by the computer program, a plurality of summaries of historical conversations from a database of historical conversation summaries similar to the query; (3) generating, by the computer program, a first prompt comprising the query and the plurality of summaries; (4) submitting, by the computer program, the first prompt to a first large language model (LLM); (5) receiving, by the computer program and from the first LLM, a first response; (6) presenting, by the computer program, the first response to the user; (7) generating, by the computer program, a second prompt for a summary of the query and the first response; (8) submitting, by the computer program, the second prompt to a second LLM; and (9) saving, by the computer program, a second response to the second prompt from the second LLM to the database of historical conversation summaries, wherein the second response may include the summary.

In one embodiment, the method may also include generating, by the computer program, an embedding vector for the query. The computer program retrieves the plurality of summaries of historical conversations from the database of historical conversation summaries using the embedding vector for the query.

In one embodiment, the computer program compares the embedding vector for the query to embedding vectors for each of the plurality of summaries.

In one embodiment, a certain number of summaries having embedding vectors with values closest to a value for the embedding vector for the query are retrieved.

In one embodiment, the summary may be saved to the database of historical conversation summaries in response to an embedding vector for the summary being distinct from embedding vectors for the plurality of summaries in the database.

In one embodiment, the method may also include removing, by the computer program, one of the plurality of summaries in the database in response to an embedding vector for the summary having a value that may be similar to an embedding vector for the one of the plurality of summaries.

In one embodiment, the first LLM and the second LLM may be the same LLM.

In one embodiment, the computer program may include a user interface computer program and a prompt generator computer program.

According to another embodiment, a system may include: a user electronic device; a database comprising historical conversation summaries; a first large language model (LLM); and a second LLM. The user electronic device may be configured to receive a query from user, to retrieve a plurality of summaries of historical conversations from a database of historical conversation summaries similar to the query, to generate a first prompt comprising the query and the plurality of summaries, to submit the first prompt to the first LLM; to receive a first response from the first LLM; to present the first response to the user, to generate a second prompt for a summary of the query and the first response, to submit the second prompt to the second LLM, and to save a second response to the second prompt from the second LLM to the database of historical conversation summaries, wherein the second response may include the summary. The first LLM may be configured to generate the first response. The second LLM may be configured to generate the second response.

In one embodiment, the user electronic device may be further configured to generate an embedding vector for the query and to retrieve the plurality of summaries of historical conversations from the database of historical conversation summaries using the embedding vector for the query.

In one embodiment, the user electronic device may be further configured to compare the embedding vector for the query to embedding vectors for each of the plurality of summaries.

In one embodiment, a certain number of summaries having embedding vectors with values closest to a value for the embedding vector for the query are retrieved.

In one embodiment, the summary may be saved to the database of historical conversation summaries in response to an embedding vector for the summary being distinct from embedding vectors for the plurality of summaries in the database.

In one embodiment, the user electronic device may be further configured to remove one of the plurality of summaries in the database in response to an embedding vector for the summary having a value that may be similar to an embedding vector for the one of the plurality of summaries.

In one embodiment, the first LLM and the second LLM may be the same LLM.

In one embodiment, the user electronic device executes a user interface computer program and a prompt generator computer program.

According to another embodiment, a non-transitory computer readable storage medium, including instructions stored thereon, which when read and executed by one or more computer processors, cause the one or more computer processors to perform steps comprising: receiving a query from a user; retrieving a plurality of summaries of historical conversations from a database of historical conversation summaries similar to the query; generating a first prompt comprising the query and the plurality of summaries; submitting the first prompt to a first large language model (LLM); receiving, from the first LLM, a first response; presenting, the first response to the user; generating a second prompt for a summary of the query and the first response; submitting the second prompt to a second LLM; and saving a second response to the second prompt from the second LLM to the database of historical conversation summaries, wherein the second response may include the summary.

In one embodiment, the non-transitory computer readable storage medium may also include instructions stored thereon, which when read and executed by one or more computer processors, cause the one or more computer processors to perform steps comprising: generating an embedding vector for the query; and retrieving the plurality of summaries of historical conversations from the database of historical conversation summaries using the embedding vector for the query by comparing the embedding vector for the query to embedding vectors for each of the plurality of summaries, wherein a certain number of summaries having embedding vectors with values closest to a value for the embedding vector for the query are retrieved.

In one embodiment, the non-transitory computer readable storage medium may also include instructions stored thereon, which when read and executed by one or more computer processors, cause the one or more computer processors to perform steps comprising: saving the summary to the database of historical conversation summaries in response to an embedding vector for the summary being distinct from embedding vectors for the plurality of summaries in the database.

In one embodiment, the non-transitory computer readable storage medium may also include instructions stored thereon, which when read and executed by one or more computer processors, cause the one or more computer processors to perform steps comprising: removing one of the plurality of summaries in the database in response to an embedding vector for the summary having a value that may be similar to an embedding vector for the one of the plurality of summaries.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for enhanced conversational performance of large language models using adaptive retrieval-augmented generation according to an embodiment;

FIG. 2 depicts a method for enhanced conversational performance of large language models using adaptive retrieval-augmented generation according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for enhanced conversational performance of large language models using adaptive retrieval-augmented generation.

Embodiments may use a large language model (LLM)-based change analyzer that can provide change incidents records in natural language style based on user-LLM conversations. Embodiments may leverage the power of LLMs digesting huge historical texts data records that can be later used for root cause analysis of incidents. Embodiments may enable querying change incidents records using natural language.

Embodiments may use Adaptive Retrieval-Augmented Generation (Adaptive RAG) to handle various types of potential issues that involve generating a SQL query with syntax error, retrieving empty data, dealing with variety of users with different types and levels of technical backgrounds, and minimizing the number of conversations between the user and the LLM. Adaptive RAG enables using context retrieved from a database that is adaptively updated based on historical conversations.

Retrieval-Augmented Generation is described in Lewis, P., et al., “Retrieval-Augmented Generation for Knowledge-Intensive NLP Tasks,” ArXiv, abs/2005.11401 (2020), the disclosure of which is hereby incorporated, by reference, in its entirety.

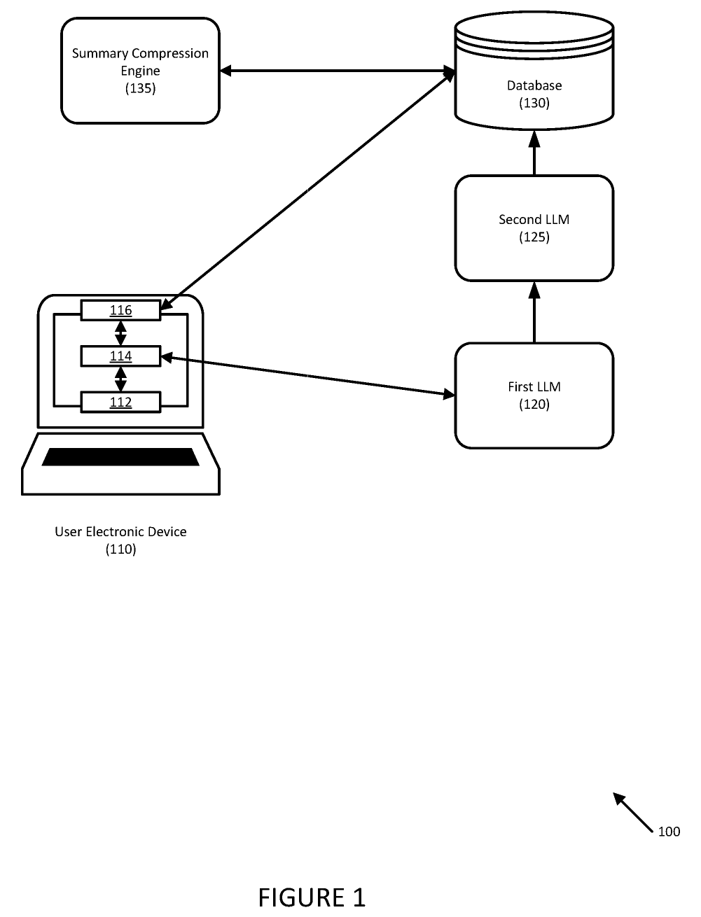

FIG. 1 depicts a system for enhanced conversational performance of large language models using adaptive retrieval-augmented generation according to an embodiment. System 100 may include user electronic device 110, which may be a computer (e.g., workstation, desktop, laptop, notebook, tablet, etc.), smart device (e.g., smart phone, smart watch, etc.), an Internet of Things (IoT) appliance, etc. User electronic device 110 may further include a computer accessing a server (not shown) using a browser or application.

User electronic device may execute a plurality of computer programs or applications, including user interface computer program 112, prompt generator computer program 114 and adaptive RAG agent 116. User interface computer program 112 may be a computer program or application in which a user may enter a query for a LLM, such as first LLM 120.

First LLM 120 may be any suitable LLM that may receive a prompt in natural language and may return a response to the prompt. First LLM 120 may be a pretrained LLM, such as Generative Pre-trained Transformer (GPT) 3, 3.5, 4, LLaMA 2, etc.

Prompt generator computer program 114 may receive the query from user interface computer program 112 and may interface with adaptive RAG agent 116 to retrieve context for historical conversations with first LLM 120 from database 130. Database 130 may include domain knowledge-based information and summaries of historical conversations with the user and/or other. Based on the prompt, adaptive RAG agent 116 may query database 130 for the context and may provide the context to prompt generator computer program 114. Prompt generator computer program 114 may the provide the query received from the user and the context to first LLM 120, which may generate a response to the prompt.

Although user interface computer program 112, prompt generator computer program 114, and adaptive RAG agent 116 are illustrated as being executed by user electronic device 110, it should be noted that any or all of these elements may be executed by a server and/or in the cloud as is necessary and/or desired.

First LLM 120 may return the response to the prompt to user interface computer program 112.

First LLM 120 may also provide the response and the prompt to second LLM 125, which may generate a summary of the conversation. Second LLM may be any suitable pretrained LLM. Second LLM 125 may provide the summary to database 130, which may be updated with the summary.

In one embodiment, an embedding vector for each summary may be stored with the associated summary.

In one embodiment, before being saved to database 130, similar summaries in database 130 may be removed, while distinct summaries may be added. In one embodiment, summary compression engine 135 may review the summaries in database 130 and may remove similar summaries, thereby compressing the contents of database 130 and keeping database 130 at a manageable size.

In one embodiment, database 130 may be a graph-based database that may identify and retrieve retrieving relevant summaries for any user’s input in order to generate a good context in an efficient manner.

Although two LLMs – first LLM 120 and second LLM 125 – are depicted in FIG. 1, it should be noted that a single LLM may generate the response to the prompt and may also generate the summary based on the prompt and the response.

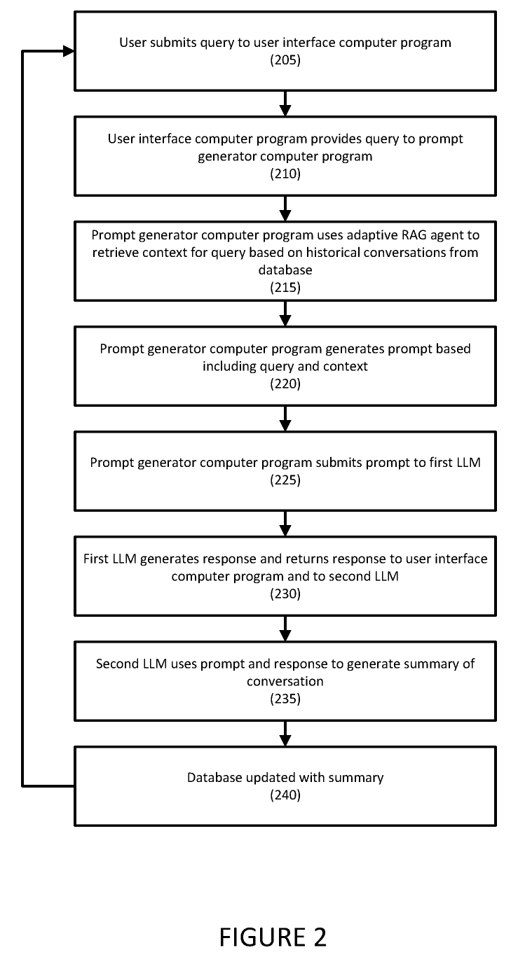

Referring to FIG. 2, a method for enhanced conversational performance of large language models using adaptive retrieval-augmented generation is disclosed according to an embodiment.

In step 205, a user may submit a query for a LLM to a user interface computer program executed by a user electronic device.

In step 210, the user interface computer program may provide the query to a prompt generator computer program.

In one embodiment, the interface computer program or the prompt generator computer program may pre-process the query. For example, in embodiments, the interface computer program or the prompt generator computer program may standardize the format for dates in the query.

In step 215, the prompt generator computer program may use an adaptive RAG agent to retrieve context (i.e., the text of summaries of historical conversations) for the query from a database that stores summaries of historical conversations. For example, the prompt generator computer program may generate an embedding vector of the query and may compare the embedding vector for the query to embedding vectors for the summaries of historical conversations in the database. The prompt generator computer program may retrieve the summaries of historical conversations that have embedding vectors that are close to the embedding vector for the query.

In one embodiment, the number of summaries retrieved may be a parameter that may be provided by the user submitting the query, or it may be set by the prompt generator computer program. For example, if the 10 most relevant summaries are to be retrieved, the prompt generation computer program may retrieve the 10 summaries with embedding vectors that are closest to the embedding vector for the query.

Additional filtering, such as filtering the summaries to the most recent summaries, summaries involving the user submitting the query, etc. may be used as is relevant and/or desired.

In one embodiment, the adaptive RAG agent may submit a SQL query to the database to retrieve the context – the relevant summaries – from the database.

In step 220, the prompt generator computer program may generate a prompt using the query and the context from the adaptive RAG agent, and in step 225, may submit the prompt to the first LLM.

In step 230, the first LLM may process the prompt and may generate a response to the prompt. The first LLM may return the response to the user interface computer program and may also provide it to a second LLM.

In one embodiment, the user interface computer program may perform post-processing on the response. For example, if a date range was included in the query, and the response includes information from outside of the date range, the response may be revised to remove the out-of-scope information.

In step 235, the second LLM may receive the prompt and the response and may generate a summary of the conversation. For example, the conversation may be provided to the second LLM in a prompt with a request for a summary. The prompt may include parameters, such as a maximum length, systems involved, the user involved in the conversation, etc.

In one embodiment, the second LLM may identify critical elements of the summary to include in order to generate a good summary. For example, by reviewing the conversations, the second LLM may identify critical elements, repeated, and redundant parts, to generate the summary.

In step 240, the database may be updated with the summary. For example, a summary compression engine may review the summary and may compare it to existing summaries in the database. For example, the summary compression engine may compare an embedding vector to the embedding vectors for the stored summaries and may remove similar summaries from the database. If the summary is distinct, it will be stored in the database.

In one embodiment, the embedding vector for the summary may be stored with the summary in the database.

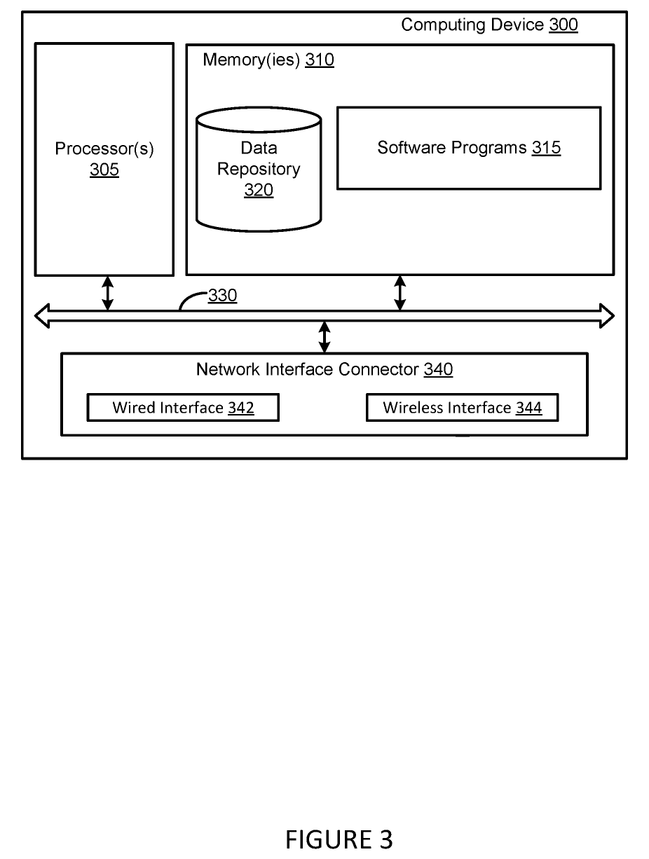

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a computer program, a query from a user;
retrieving, by the computer program, a plurality of summaries of historical conversations from a database of historical conversation summaries similar to the query;
generating, by the computer program, a first prompt comprising the query and the plurality of summaries;
submitting, by the computer program, the first prompt to a first large language model (LLM);
receiving, by the computer program and from the first LLM, a first response;
presenting, by the computer program, the first response to the user;
generating, by the computer program, a second prompt for a summary of the query and the first response;
submitting, by the computer program, the second prompt to a second LLM; and
saving, by the computer program, a second response to the second prompt from the second LLM to the database of historical conversation summaries, wherein the second response comprises the summary.

2. The method of claim 1, further comprising:
generating, by the computer program, an embedding vector for the query;
wherein the computer program retrieves the plurality of summaries of historical conversations from the database of historical conversation summaries using the embedding vector for the query.

3. The method of claim 2, wherein the computer program compares the embedding vector for the query to embedding vectors for each of the plurality of summaries.

4. The method of claim 3, wherein a certain number of summaries having embedding vectors with values closest to a value for the embedding vector for the query are retrieved.

5. The method of claim 1, wherein the summary is saved to the database of historical conversation summaries in response to an embedding vector for the summary being distinct from embedding vectors for the plurality of summaries in the database.

6. The method of claim 1, further comprising:
removing, by the computer program, one of the plurality of summaries in the database in response to an embedding vector for the summary having a value that is similar to an embedding vector for the one of the plurality of summaries.

7. The method of claim 1, wherein the first LLM and the second LLM are the same LLM.

8. The method of claim 1, wherein the computer program comprises a user interface computer program and a prompt generator computer program.

9. A system, comprising:
a user electronic device;
a database comprising historical conversation summaries;
a first large language model (LLM); and
a second LLM;
wherein the user electronic device is configured to receive a query from user, to retrieve a plurality of summaries of historical conversations from a database of historical conversation summaries similar to the query, to generate a first prompt comprising the query and the plurality of summaries, to submit the first prompt to the first LLM; to receive a first response from the first LLM; to present the first response to the user, to generate a second prompt for a summary of the query and the first response, to submit the second prompt to the second LLM, and to save a second response to the second prompt from the second LLM to the database of historical conversation summaries, wherein the second response comprises the summary;
the first LLM is configured to generate the first response; and
the second LLM is configured to generate the second response.

10. The system of claim 9, wherein the user electronic device is further configured to generate an embedding vector for the query and to retrieve the plurality of summaries of historical conversations from the database of historical conversation summaries using the embedding vector for the query.

11. The system of claim 10, wherein the user electronic device is further configured to compare the embedding vector for the query to embedding vectors for each of the plurality of summaries.

12. The system of claim 11, wherein a certain number of summaries having embedding vectors with values closest to a value for the embedding vector for the query are retrieved.

13. The system of claim 9, wherein the summary is saved to the database of historical conversation summaries in response to an embedding vector for the summary being distinct from embedding vectors for the plurality of summaries in the database.

14. The system of claim 9, wherein the user electronic device is further configured to remove one of the plurality of summaries in the database in response to an embedding vector for the summary having a value that is similar to an embedding vector for the one of the plurality of summaries.

15. The system of claim 9, wherein the first LLM and the second LLM are the same LLM.

16. The system of claim 9, wherein the user electronic device executes a user interface computer program and a prompt generator computer program.

17. A non-transitory computer readable storage medium, including instructions stored thereon, which when read and executed by one or more computer processors, cause the one or more computer processors to perform steps comprising:
receiving a query from a user;
retrieving a plurality of summaries of historical conversations from a database of historical conversation summaries similar to the query;
generating a first prompt comprising the query and the plurality of summaries;
submitting the first prompt to a first large language model (LLM);
receiving, from the first LLM, a first response;
presenting, the first response to the user;
generating a second prompt for a summary of the query and the first response;
submitting the second prompt to a second LLM; and
saving a second response to the second prompt from the second LLM to the database of historical conversation summaries, wherein the second response comprises the summary.

18. The non-transitory computer readable storage medium of claim 17, further including instructions stored thereon, which when read and executed by one or more computer processors, cause the one or more computer processors to perform steps comprising:
generating an embedding vector for the query; and
retrieving the plurality of summaries of historical conversations from the database of historical conversation summaries using the embedding vector for the query by comparing the embedding vector for the query to embedding vectors for each of the plurality of summaries, wherein a certain number of summaries having embedding vectors with values closest to a value for the embedding vector for the query are retrieved.

19. The non-transitory computer readable storage medium of claim 17, further including instructions stored thereon, which when read and executed by one or more computer processors, cause the one or more computer processors to perform steps comprising:
saving the summary to the database of historical conversation summaries in response to an embedding vector for the summary being distinct from embedding vectors for the plurality of summaries in the database.

20. The non-transitory computer readable storage medium of claim 17, further including instructions stored thereon, which when read and executed by one or more computer processors, cause the one or more computer processors to perform steps comprising:
removing one of the plurality of summaries in the database in response to an embedding vector for the summary having a value that is similar to an embedding vector for the one of the plurality of summaries.
